(19) United States
(12) Patent Application Publication
(10) Pub. No.: US 2017/0274612 A1
(43) Pub. Date: Sep. 28, 2017

(54) GLUING DEVICE AND CARTON-FORMING MACHINE HAVING SAME

(71) Applicant: MITSUBISHI HEAVY INDUSTRIES PRINTING & PACKAGING MACHINERY, LTD., Mihara-shi, Hiroshima (JP)

(72) Inventors: Mitsuhiro NADACHI, Mihara-shi, Hiroshima (JP); Osamu HATANO, Mihara-shi, Hiroshima (JP)

(21) Appl. No.: 15/504,701

(22) PCT Filed: Sep. 28, 2015
(86) PCT No.: PCT/JP2015/077250

§ 371 Date: Feb. 17, 2017

(30) Foreign Application Priority Data
Oct. 6, 2014 (JP) 2014-205849

(51) Int. Cl. B31B 1/62; B05C 5/02; B05C 11/10

(52) U.S. Cl. CPC B31B 1/62; B31B 1/88; B31B 1/26; B31B 1/25; B05C 5/025; B05C 11/1005; B31B 2201/6017; B31B 2201/25; B31B 2201/26; B31B 2201/88; B31B 2203/08

(57) ABSTRACT

A gluing device has a sheet guide for guiding a corrugated fiberboard; a basal part having a fixed relative position with respect to the sheet guide; a support part moveable with respect to the basal part; a glue gun for contacting and applying glue to a glued portion within a seam margin at a side edge of a corrugated fiberboard passing through the sheet guide; a first energizing mechanism for energizing the support part towards the sheet guide; a second energizing mechanism for energizing the support part away from the sheet guide; and a position adjustment mechanism arranged between the first energizing mechanism and the basal part, for steples sly adjusting the position of the support part in a direction lying in the direction of the force exerted by the first energizing mechanism, and adjusting the gap between the glue gun and the sheet guide.

### TECHNICAL FIELD

The present invention relates to a gluing device and a carton-forming machine having the same.

### BACKGROUND ART

A general carton-forming machine manufactures a carton body (corrugated carton) by processing a sheet material (for example, a corrugated fiberboard), and includes a sheet feeding section, a sheet discharging section, a printing section, a die-cut section, a folding section, and counter-ejector section. Here, in the folding section, after glue is applied to the corrugated fiberboard, the corrugated fiberboard is folded, and end portions of the corrugated fiberboard are attached to each other. A gluing device of the corrugated fiberboard is disposed in the folding section, and the gluing device applies glue to a seam margin on a side end of the corrugated fiberboard processed by the sheet discharging section using a glue gun or a glue wheel.

For example, as the gluing device, a gluing device is suggested, which includes a contact type glue gun, a first pressurizing device which applies a pressurization force to the glue gun in a direction to cancel off the self weight of the glue gun, a pressure sensor which is provided in a corrugated fiberboard traveling line on the upstream side of the glue gun in the traveling direction of the corrugated fiberboard and comes into contact with the corrugated fiberboard to detect a reaction force received from the corrugated fiberboard, and a second pressurizing device which is disposed in the vicinity of the glue application position and applies a pressurization force which is set according to the reaction force detection value when the glue is applied to the seam margin of the corrugated fiberboard (refer to PTL 1). In addition, as the gluing device, a slot die extrusion type coating device is known, which includes a pressurizing mechanism which applies a contact pressure to the tip of a nozzle from which glue is applied and a corrugated fiberboard, and a balance weight mechanism which applies a force in a direction opposite to the pressurizing mechanism. (refer to PTL 2).

### CITATION LIST

### Patent Literature

[PTL 1] Japanese Unexamined Patent Application Publication No. 2010-52211

[PTL 2] Japanese Unexamined Patent Application Publication No. 2000-334351

### SUMMARY OF INVENTION

### Technical Problem

One carton-forming machine processes a corrugated fiberboard having various thicknesses and materials in corrugated cartons having various shapes. Here, in the case where a contact type glue gun is used as a gluing device, if the contact force between a glue gun nozzle and a corrugated fiberboard becomes weak, the glue is drawn between the corrugated fiberboard and the nozzle, and the applied glue is scattered around. In addition, the force of contact between the glue gun and a corrugated fiberboard becomes strong, the corrugated fiberboard is bent or deformed and glue cannot be applied to an appropriate position. Therefore, it is necessary to cause the gluing device to come into contact with the glue gun in an appropriate state even in a case where the thickness and material of the corrugated fiberboard is changed.

The present invention is made to solve the above-described problems, and an object thereof is to provide a gluing device capable of appropriately applying glue to various corrugated fiberboards, and a carton-forming machine having the same.

### Solution to Problem

According to the present invention, there is provided gluing device, including: a sheet guide which guides a corrugated fiberboard; a basal part which has a fixed relative position with respect to the sheet guide; a support part which is disposed so as to be relatively movable with respect to the basal part; a glue gun which is fixed at a position of the support part facing the sheet guide, and comes into contact with and applies glue to a glued portion within a seam margin at a side end of the corrugated fiberboard passing through the sheet guide; a first energizing mechanism which is disposed between the basal part and the support part and energizes the support part in a direction toward the sheet guide; a second energizing mechanism which is disposed between the basal part and the support part and energizes the support part in a direction away from the sheet guide; and a position adjustment mechanism which is disposed between the first energizing mechanism and the basal part, steplessly adjusts a position of the support part in a direction along a direction of a force exerted by the first energizing mechanism, and adjusts a gap between the glue gun and the sheet guide.

In this way, since the gap between the glue gun and the sheet guide can be steplessly adjusted by the position adjustment mechanism, it is possible to adjust the gap according to the thickness and material of corrugated fiberboard. Accordingly, since the corrugated fiberboard can be appropriately interposed between the glue gun and the sheet guide and it is possible to appropriately adjust a force by which the glue gun is pressed to the corrugated fiberboard, it is possible to appropriately apply glue to various corrugated fiberboards.

In the gluing device of the present invention, the position adjustment mechanism rotates an eccentric cam to adjust the position of the support part.

Accordingly, it is possible to steplessly adjust the position by a simple structure.

In the gluing device of the present invention, the first energizing mechanism includes a spring, and the second energizing mechanism is an air cylinder.

Accordingly, it is possible to more appropriately adjust an energizing force which acts on the corrugated fiberboard from the glue gun.

In the gluing device of the present invention, the gluing device further includes a position detector which detects the position of the support part in the direction along the direction of the force exerted by the first energizing mechanism, and a controller which controls the operation of the position adjustment mechanism on the basis of the position detected by the position detector and adjusts the gap.

Accordingly, it is possible to adjust the force which presses the glue gun on corrugated fiberboard to be an appropriate force.

In gluing device of the present invention, the position detector is disposed on a surface opposite to the surface on which the glue gun of the support part is disposed.

Accordingly, it is possible to adjust the force which presses the glue gun to the corrugated fiberboard to be an appropriate force.

In the gluing device of the present invention, the controller acquires information on the corrugated fiberboard, widens the gap as a flute of the corrugated fiberboard is soft, and narrows the gap as the flute is hard.

Accordingly, it is possible to adjust the force which presses the glue gun to the corrugated fiberboard to be an appropriate force.

In the gluing device of the present invention, the gluing device further includes a glue inspection unit which is disposed on the downstream side of the glue gun in a transport direction of the corrugated fiberboard and detects the glue applied to the corrugated fiberboard, in which the controller adjusts the gap on the basis of the result by the glue inspection unit.

Accordingly, it is possible to adjust the force which presses the glue gun to the corrugated fiberboard to be an appropriate force.

In the gluing device of the present invention, the gluing device further includes a reaction force detection device which is disposed on the upstream side of the glue gun in the transport direction of the corrugated fiberboard and comes into contact with the corrugated fiberboard to detect a reaction force received from the corrugated fiberboard, in which the controller adjusts the gap on the basis of the result by the reaction force detection device.

Accordingly, it is possible to adjust the force which presses the glue gun to the corrugated fiberboard to be an appropriate force.

According to the present invention, there is provided a carton-forming machine, including: a sheet feeding section which supplies a corrugated fiberboard; a printing section which performs printing on the corrugated fiberboard; a sheet discharging section which applies creasing lines to and forms grooves on the surface of the corrugated fiberboard; a sheet folding device which includes the above-described gluing device, applies glue to a glued portion within a seam margin on a side end of the corrugated fiberboard, and folds both end portions of the corrugated fiberboard in a width direction to join both end portions of the corrugated fiberboard in the width direction and form a carton body; and a counter-ejector section which stacks the carton bodies while counting the carton bodies and thereafter, discharges the carton bodies for each predetermined number.

In this way, since the gap between the glue gun and the sheet guide can be steplessly adjusted by the position adjustment mechanism, it is possible to adjust the gap according to the thickness and material of corrugated fiberboard. Accordingly, since the corrugated fiberboard can be appropriately interposed between the glue gun and the sheet guide and it is possible to appropriately adjust a force by which the glue gun is pressed to the corrugated fiberboard, it is possible to appropriately apply glue to various corrugated fiberboards. Therefore, it is possible to improve the productivity.

### Advantageous Effects of Invention

According to the present invention, since the gap between the glue gun and the sheet guide can be steplessly adjusted by the position adjustment mechanism, it is possible to adjust the gap according to the thickness and material of corrugated fiberboard. Accordingly, since the corrugated fiberboard can be appropriately interposed between the glue gun and the sheet guide and it is possible to appropriately adjust a force by which the glue gun is pressed to the corrugated fiberboard, it is possible to appropriately apply glue to various corrugated fiberboards.

### BRIEF DESCRIPTION OF DRAWINGS

FIG. 1 is a schematic configuration view showing a carton-forming machine of the present embodiment.

FIG. 2 is a schematic configuration view of a folding section according to the present embodiment.

FIG. 3 is a sectional view when the folding section according to the present embodiment is cut along a plane orthogonal to a transport direction.

FIG. 4 is a schematic configuration view of a gluing device.

FIG. 5 is a schematic configuration view of a gluing device main body.

FIG. 6 is a front view showing configurations of a gluing device main body and the glue detection device.

FIG. 7 is a sectional view taken along line A-A of FIG. 6.

FIG. 8 is a schematic configuration view of a gluing device of a modification example.

FIG. 9 is a schematic configuration view of a gluing device of another modification example.

FIG. 10 is a flowchart showing an example of a control operation of the gluing device.

FIG. 11 is a flowchart showing another example of the control operation of the gluing device.

FIG. 12 is a flowchart showing still another example of the control operation of the gluing device.

FIG. 13 is a flowchart showing still another example of the control operation of the gluing device.

### DESCRIPTION OF EMBODIMENTS

A preferred embodiment of a gluing device according to the present invention and a carton-forming machine having the same will be described in detail with reference to the accompanying drawings. In addition, the present invention is not limited by the embodiment, and in a case where several embodiments are provided, the present invention includes those which are obtained by combining the embodiments.

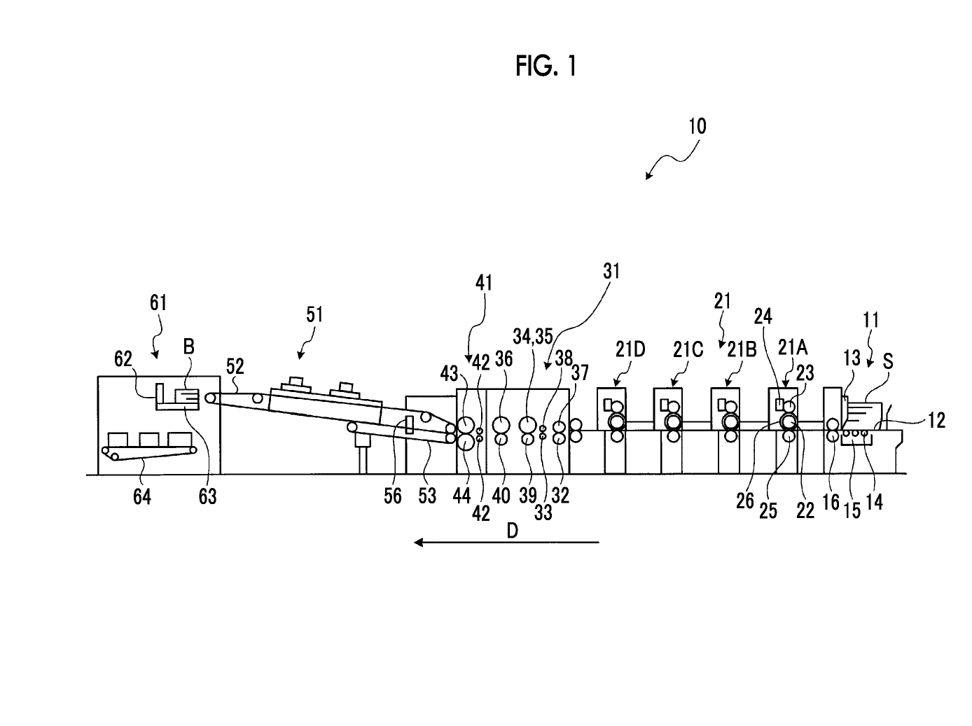

FIG. 1 is a schematic configuration view showing a carton-forming machine of the present embodiment. As shown in FIG. 1, a carton-forming machine 10 of the present embodiment manufactures a corrugated carton (carton body) B by processing a corrugated fiberboard (sheet) S. The carton-forming machine 10 includes a sheet feeding section 11, a printing section 21, a sheet discharging section 31, a die-cut section 41, a folding section 51, and a counter-ejector section 61 which are linearly disposed in a direction (transport direction) D in which the corrugated fiberboard S and the corrugated carton B are transported.

In the sheet feeding section 11, the corrugated fiberboards S are fed to the printing section 21 one by one at a constant speed. The sheet feeding section 11 includes a table 12, a front stopper 13, a supply roller 14, a suction unit 15, and a feed roll 16. Several corrugated fiberboards S are placed on the table 12 so as to be stacked, and the table 12 is supported so as to be lifted and lowered. The front stopper 13 can position the front end position of each of the corrugated fiberboards S stacked on the table 12, and a gap which allows one corrugated fiberboard S to pass through a portion between the lower end portion of the front stopper 13 and the table 12 is secured. Several supply rollers 14 are disposed corresponding to the table 12 in the transport direction D of the corrugated fiberboard S. When the table 12 is lowered, the corrugated fiberboard S located at the lowermost position among several stacked corrugated fiberboards S can be fed forward by the supply rollers 14. The stacked corrugated fiberboards S are suctioned downward, that is, toward the table 12 side or the supply roller 14 side by the suction unit 15. The feed roll 16 can provide the corrugated fiberboard S fed by the supply rollers 14 to the printing section 21.

The printing section 21 performs multi-color printing (in the present embodiment, four-color printing) on the surface of the corrugated fiberboard S. In the printing section 21, four printing units 21A, 21B, 21C, and 21D are disposed in series, and printing can be performed on the surface of the corrugated fiberboard S using four ink colors. The printing units 21A, 21B, 21C, and 21D are approximately similarly configured to each other, and each of the printing units 21A, 21B, 21C, and 21D includes a printing cylinder 22, an ink supply roll (anilox roll) 23, an ink chamber 24, and a receiving roll 25. A printing die 26 is mounted to the outer periphery portion of the printing cylinder 22, and the printing cylinder 22 is rotatably provided. The ink supply roll 23 is disposed so as to contact against the printing die 26 in the vicinity of the printing cylinder 22, and is rotatably provided. The ink chamber 24 stores ink and is provided in the vicinity of the ink supply roll 23. The corrugated fiberboard S is interposed between the receiving roll 25 and the printing cylinder 22, the receiving roll 25 transports the corrugated fiberboard S while applying a predetermined printing pressure to the corrugated fiberboard S, and the receiving roll 25 is rotatably provide so as to face the lower portion of the printing cylinder 22. In addition, although it is not shown, a pair of upper and lower feed rolls is provided before and after each of the printing units 21A, 21B, 21C, and 21D.

In the sheet discharging section 31, creasing lines are applied to the corrugated fiberboard S and grooves are performed on the corrugated fiberboard S. The sheet discharging section 31 includes a first creasing line roll 32, a second creasing line roll 33, a slitter knife 34, a first slotter head 35, and a second slotter head 36.

The first creasing line roll 32 is formed in a circular shape, and several (four in the present embodiment) first creasing line rolls 32 are disposed at predetermined intervals in a horizontal direction orthogonal to the transport direction D of the corrugated fiberboard S and can be rotated by a drive device (not shown). The second creasing line roll 33 is formed in a circular shape, and several (four in the present embodiment) first creasing line rolls 32 are disposed at predetermined intervals in the horizontal direction orthogonal to the transport direction D of the corrugated fiberboard S and can be rotated by a drive device (not shown). In this case, the first creasing line roll 32 disposed on the lower side applies creasing lines to the back surface (lower surface) of the corrugated fiberboard S. Similarly to the first creasing line roll 32, the second creasing line roll 33 disposed on the lower side applies creasing lines to the back surface (lower surface) of the corrugated fiberboard S, and the receiving rolls 37, 38 are provided so as to be rotatable in synchronization with the creasing line rolls 32 and 33 at the upper position facing to the creasing line rolls 32 and 33.

Each of the slitter knife 34 and the first slotter head 35 is formed in a circular shape, and several (five in the present embodiment) slitter knifes 34 and first slotter heads 35 are disposed at predetermined intervals in the horizontal direction orthogonal to the transport direction D of the corrugated fiberboard S and can be rotated by a driving device (not shown). One slitter knife 34 is configured, is provided corresponding to the end portion in the width direction of the transported corrugated fiberboard S, and can cut the end portion in the width direction of the corrugated fiberboard S. Four first slotter heads 35 are configured, are provided corresponding to a predetermined position in the width direction of the transported corrugated fiberboard S, and can form grooves at a predetermined position in the corrugated fiberboard S. Similarly, four second slotter heads 36 are configured, are provided corresponding to a predetermined position in the width direction of the transported corrugated fiberboard S, and can form grooves at a predetermined position in the corrugated fiberboard S. In this case, lower blades 39 and 40 are provided so as to be rotatable in synchronization with the slitter knife 34 and the first and second slotter heads 35 and 36 at the lower position facing to the slitter knife 34 and the first and second slotter heads 35 and 36.

In the die-cut section 41, drilling for hand holes is performed on the corrugated fiberboard S. The die-cut section 41 includes a pair of upper and lower feed pieces 42, an anvil cylinder 43 and a knife cylinder 44. The feed pieces 42 are rotatably provided such that the corrugated fiberboard S is transported in a state where the corrugated fiberboard S is interposed between the upper portion and the lower portion. Each of the anvil cylinder 43 and the knife cylinder 44 is formed in a circular shape and the anvil cylinder 43 and the knife cylinder 44 are rotatable in synchronization with each other by a drive device (not shown). In this case, a cutter mount is provided at a predetermined position in the outer peripheral portion of the knife cylinder 44 while an anvil is formed on the outer periphery portion of the anvil cylinder 43.

In the folding section 51, the corrugated fiberboard S is folded while being transported in the transport direction D, and both end portions of the corrugated fiberboard S in the width direction are joined to each other so as to form a flat corrugated carton B.

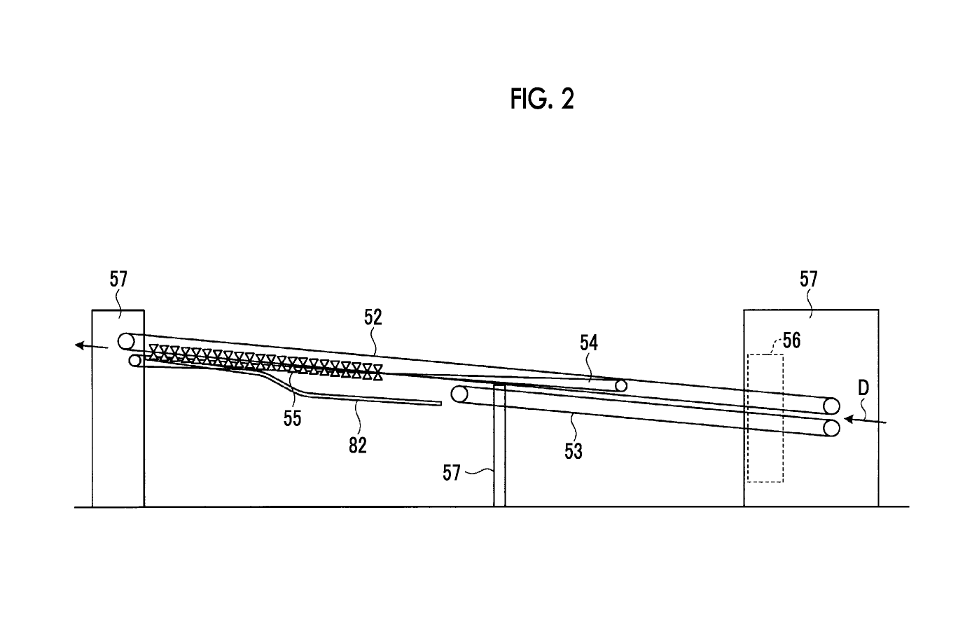

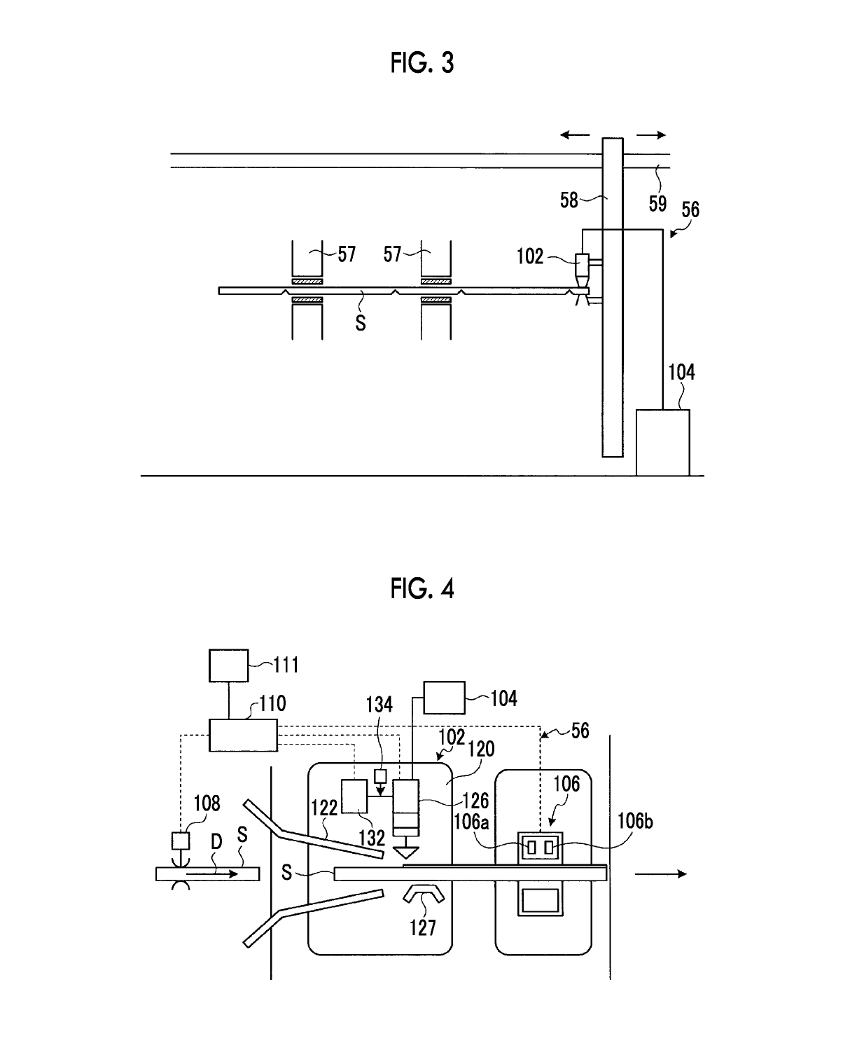

Next, the folding section 51 of the carton-forming machine 10 will be described in detail with reference to FIGS. 2 and 3. FIG. 2 is a schematic configuration view of the folding section according to the present embodiment. FIG. 3 is a sectional view when the folding section according to the present embodiment is cut along a plane orthogonal to a transport direction. The folding section 51 of the present embodiment folds the glued corrugated fiberboard S so as to form a flat corrugated carton B. The folding section 51 includes an upper transport belt 52, a lower transport belt 53, a forming belt 54, a pair of folding bars 82, several gauge rollers 55, a gluing device 56, a main frame 57, a glue frame 58, and a movement mechanism 59.

The upper transport belt 52 is provided on the upper side in the vertical direction and is provided over the entire length of the transport direction D of the folding section 51. The upper transport belt 52 is an endless belt and is configured so as to revolve to be wound around several pulleys. The lower side of the revolving upper transport belt 52 moves in the transport direction D, and the upper side thereof moves in a direction opposite to the transport direction D.

The lower transport belt 53 is provided on the upstream side in the transport direction D of the upper transport belt 52 and is provided so as to face the upper transport belt 52. Similarly to the upper transport belt 52, the lower transport belt 53 is an endless belt, and is configured to revolve so as to be wound around several pulleys. The upper side of the revolving lower transport belt 53 moves in the transport direction D, and the lower side thereof moves in a direction opposite to the transport direction D. Accordingly, in the upstream side in the transport direction D of the folding section 51, the corrugated fiberboard S supplied to the folding section 51 is transported from the upstream side in the transport direction toward the downstream side while being interposed between the upper transport belt 52 and the lower transport belt 53.

The forming belt 54 is provided in the transport direction D on the downstream side in the transport direction D of the lower transport belt 53, is provided to abut on folding surfaces formed by bending both end portions in the width direction of the corrugated fiberboard S, that is, a first panel and a fourth panel. One of the forming belts 54 abuts on the first panel of the corrugated fiberboard S, and the other thereof abuts on the fourth panel of the corrugated fiberboard S. Similarly to the upper transport belt 52 and the lower transport belt 53, the forming belt 54 is an endless belt and is configured so as to revolve to be wound around several pulleys. Each pulley is fixed to the main frame of the folding section 51. In addition, while the forming belt 54 abuts on the first panel and the fourth panel on both sides in the width direction of the corrugated fiberboard S, the inclination angle of each forming belt 54 is inclined so as to fold the first panel and the fourth panel of the corrugated fiberboard S in the transport direction.

The pair of folding bars 82 is provided on the downstream side in the transport direction D of the folding section 51. In addition, the pair of folding bars 82 is provided so as to abut on the folding surface of the corrugated fiberboard S, that is, the first and fourth panels. That is, in the pair of folding bars 82, one folding bar 82 abuts on the first panel of the corrugated fiberboard S, and the other folding bar 82 abuts on the fourth panel of the corrugated fiberboard S. In addition, while the pair of folding bars 82 abuts on the first panel and the fourth panel on both sides in the width direction of the corrugated fiberboard S, the position of each folding bar 82 is curved so as to fold the first and fourth panels of the corrugated fiberboard S in the transport direction D.

Several gauge rollers 55 are provided on the downstream side of the lower transport belt 53 in the transport direction D and are provided so as to be arranged in the transport direction D. Several gauge rollers 55 are provided on both end sides of the folded and transported corrugated fiberboard S in the width direction, that is, on both end sides of the second surface and the third surface of the corrugated fiberboard S in the width direction. For this reason, the corrugated fiberboard S is transported from the upstream side toward the downstream side in the transport direction D while both end sides of the folded and transported corrugated fiberboard S in the width direction are held by several gauge rollers 55, that is, a portion between the first panel and the second surface and a portion between the third surface and the fourth panel are held by several gauge rollers 55.

The gluing device 56 is provided on the upstream side in the transport direction D of the upper transport belt 52 and the lower transport belt 53 and applies glue to the first panel of the corrugated fiberboard S. The gluing device 56 includes a gluing device main body 102 and a glue tank 104. In the gluing device 56, glue is supplied from the glue tank 104 to the gluing device main body 102, the glue is ejected from the gluing device main body 102 at a predetermined timing, and the glue can be applied to a predetermined position of the corrugated fiberboard S. The gluing device 56 will be described later.

The main frame 57 supports the upper transport belt 52, the lower transport belt 53, the forming belt 54, and the gauge roller 55. The glue frame 58 supports the gluing device main body 102. The movement mechanism 59 moves the glue frame 58 in a direction parallel to the surface of the corrugated fiberboard S facing the movement mechanism 59 and orthogonal to the transport direction D, that is, in the width direction of the corrugated fiberboard S, and moves the gluing device main body 102. The movement device 59 moves the gluing device main body 102 according to the width of the corrugated fiberboard S so as to apply glue to an arbitrary position of the corrugated fiberboard S in the width direction.

In the counter-ejector section 61, after the corrugated cartons B are stacked while being counted, the corrugated cartons B are sorted into a predetermined number of bathes, and thereafter, the sorted corrugated cartons B are discharged. The counter-ejector section 61 includes a hopper device 62. The hopper device 62 includes an elevator 63 on which corrugated cartons B are stacked and which can be lifted and lowered, and a front contact plate (not shown) which is forming means and an angle arrangement plate are provided in the elevator 63. In addition, an ejection conveyor 64 is provided below the hopper device 62.

Here, in the carton-forming machine 10 of the above-described present embodiment, an operation for manufacturing the corrugated carton B from the corrugated fiberboard S is described.

First, several corrugated fiberboards S stacked on the table 12 by the sheet feeding section 11 of the carton-forming machine 10 according to the present embodiment are positioned by the front stopper 13, and thereafter, the table 12 is lowered, the corrugated fiberboard S positioned at the lowermost position is fed by several supply rollers 14. Accordingly, the corrugated fiberboard S is supplied to the printing section 21 at a predetermined constant speed by the pair of feed rolls 16.

In the printing section 21, ink is supplied from the ink chamber 24 to the surface of the ink supply roll 23 in each of the printing units 21A, 21B, 21C, and 21D, and if the printing cylinder 22 and the ink supply roll 23 rotate, the ink on the surface of the ink supply roll 23 is transferred to the printing die 26. If the corrugated fiberboard S is transported to a portion between the printing cylinder 22 and the receiving roll 25, the corrugated fiberboard S is interposed between the printing die 26 and the receiving roll 25, and a printing pressure is applied to the corrugated fiberboard S so as to perform printing on the surface of the corrugated fiberboard S. The printed corrugated fiberboard S is transported to the sheet discharging section 31 by the feed rolls.

In the sheet discharging section 31, first, when the corrugated fiberboard S passes through the first and second creasing line rolls 32 and 33, creasing lines are formed on the corrugated fiberboard S. Subsequently, if the corrugated fiberboard S on which the creasing lines are formed passes through the slitter knife 34, the end portion of the corrugated fiberboard S is cut at the cutting position. In addition, when the corrugated fiberboard S passes through the first slotter head 35, grooves are formed at the positions of the creasing lines, and the end portion is cut. Moreover, when the corrugated fiberboard S passes through the second slotter head 36, the grooves are formed at the positions of the creasing lines, the end portion is cut, and the margin strips are formed end is cut. Thereafter, the corrugated fiberboard S in which the grooves and a margin strip for gluing are formed at the positions of the creasing lines is transported to the die-cut section 41.

In the die-cut section 41, when the corrugated fiberboard S passes through a portion between the anvil cylinder 43 and the knife cylinder 44, a hand hole is formed. In addition, the corrugated fiberboard S in which the hand hole is formed is transported to the folding section 51.

In the folding section 51, glue is applied to the margin strip for gluing by the gluing device 56 while the corrugated fiberboard S is moved in the transport direction D by the upper transport belt 52 and the lower transport belt 53, and thereafter, the corrugated fiberboard S is folded downward by the forming belt 54 with the creasing lines as base points. If this folding advances to nearly 180°, the folding force becomes stronger, the margin strip for gluing and the end portion of the corrugated fiberboard S overlapping with the margin strip for gluing are pressed so as to come into close-contact with each other, both end portions of the corrugated fiberboard S are joined, and the corrugated carton B is formed. In addition, the corrugated carton B is transported to the counter-ejector section 61.

In the counter-ejector section 61, the corrugated carton B is fed to the hopper device 62. In the corrugated carton B fed to the hopper device 62, the tip portion of the corrugated carton B in the transport direction D abuts on the front contact surface, and the corrugated cartons B are stacked on the elevator 63 in a state of being formed by the angle arrangement plate. In addition, if a predetermined number of corrugated cartons B are stacked on the elevator 63, the elevator 63 is lowered, a predetermined number of corrugated cartons B become one batch, are discharged by the ejection conveyor 64, and are fed to the post-stroke of the carton-forming machine 10.

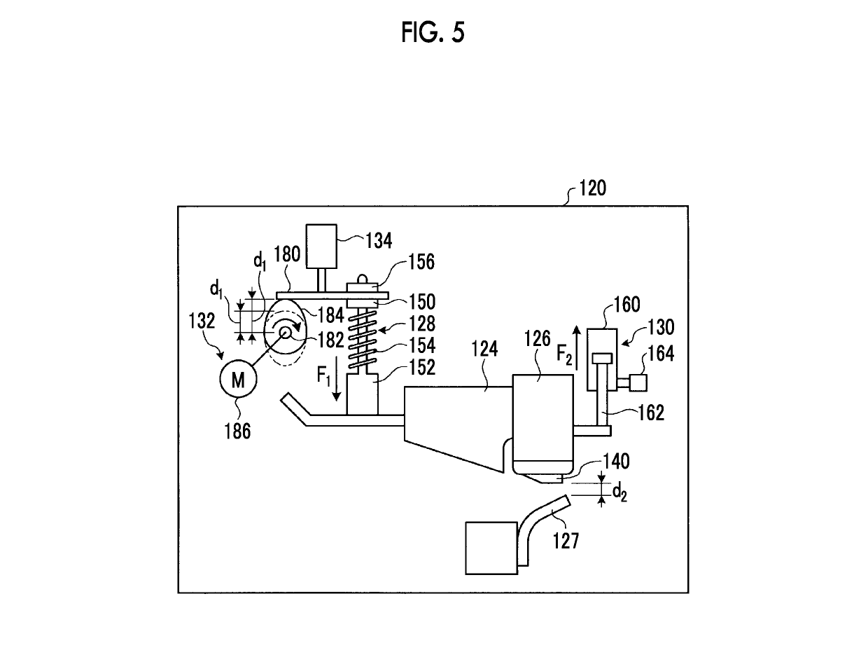

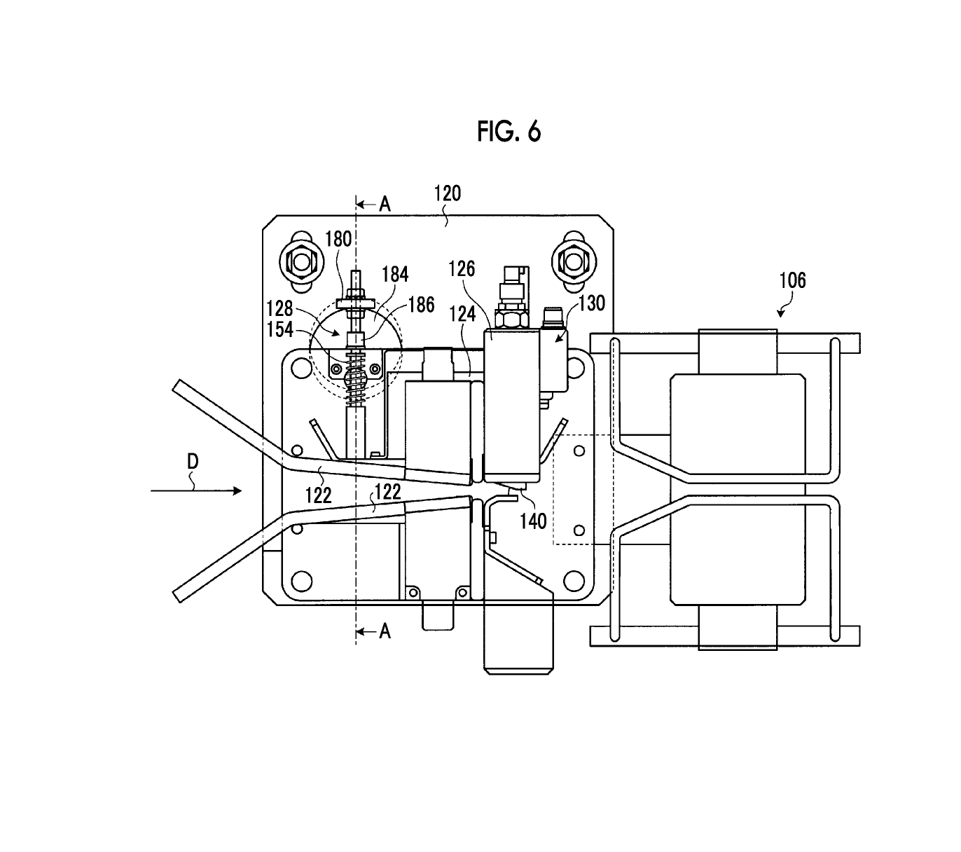

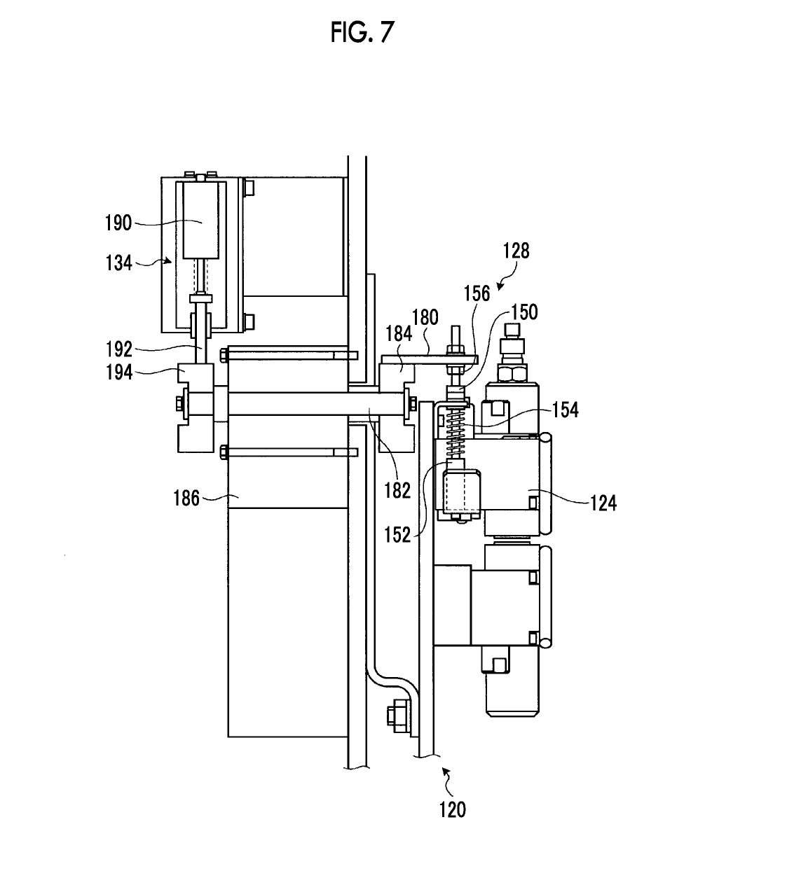

Next, the gluing device 56 of the present embodiment will be described in detail with reference to FIGS. 4 to 7. FIG. 4 is a schematic configuration view of the gluing device. FIG. 5 is a schematic configuration view of the gluing device main body. FIG. 6 is a front view showing the configurations of the gluing device main body and a glue detection device. FIG. 7 is a sectional view taken along line A-A of FIG. 6.

As shown in FIG. 4, the gluing device 56 includes a glue detection device 106, a reaction force detection device 108, a controller 110, and an operation unit 111 in addition to the gluing device main body 102 and the glue tank 104. The gluing device main body 102 applies glue to the portion to be glued of the corrugated fiberboard S. In addition, the reaction force detection device 108 may not be provided in the gluing device 56. First, the configurations other than the gluing device main body 102 will be described.

Glue is stored in the glue tank 104 and the stored glue is supplied to the gluing device main body 102.

The glue detection device 106 is disposed on the downstream side of the gluing device main body 102 in the transport direction D. The glue detection device 106 detects the state of the glue which is applied to the corrugated fiberboard S by the gluing device main body 102. The glue detection device 106 includes an imaging unit 106a and a glue amount detection unit 106b. The imaging unit 106a images the corrugated fiberboard S passing through the position facing the imaging unit 106a and detects the position at which glue is applied to the corrugated fiberboard S. The glue amount detection unit 106b detects an amount of glue or an amount of water which is applied to the corrugated fiberboard S passing through the position facing the glue amount detection unit 106b.

The reaction force detection device 108 is disposed on the upstream side of the gluing device main body 102 in the transport direction D and, is disposed on the downstream side of the position at which a seam margin and the end edge portion on the side plate opposite to the seam margin are compressed such that the sheet thickness of the glued portion of the manufactured corrugated carton does not increase. The reaction force detection device 108 is, for example, a load cell or the like, compression of the corrugated fiberboard S is brought into contact with the glued portion made, for detecting the reaction force of the corrugated fiberboard S.

The controller 110 includes a calculation processing unit such as a CPU and a storage unit such as a memory, and controls the operation of each unit of the gluing device 56. In addition, the controller 110 may be integrated with a controller which controls the operation of the carton-forming machine 10 or may be a controller which controls only the gluing device 56. The controller 110 controls the operation of a position adjustment mechanism 132 described later according to conditions stored in the storage unit, the results detected by the glue detection device 106, the results detected by the reaction force detection device 108, the operation input by an operator, or the like. In addition, the controller 110 also controls the operation of a glue gun 126 described later.

An operator inputs operations to the gluing device 56 using the operation unit 111. The operation unit 111 includes a touch panel, a button, a keyboard, or the like. The operation unit 111 is away from the region of the carton-forming device 10 to which the corrugated fiberboard S is transported, and is disposed at a position at which an operator can enter the operation unit so as to operate the operation unit 111 even during manufacture of the corrugated carton. Moreover, the operation units 111 may be disposed at several positions, and some operation units 111 may be disposed at positions at which an operator cannot enter the operation units 111 even during manufacture of the corrugated carton. The operation unit 111 sends the input operation to the controller 110.

Next, the gluing device main body 102 will be described. As shown in FIGS. 4 to 7, the gluing device main body 102 includes a basal part 120, a sheet guide 122, a support part 124, a glue gun 126, a sheet guide 127, a first energizing mechanism 128, a second energizing mechanism 130, a position adjustment mechanism 132, and a position detector 134.

The basal part 120 is a member which is fixed to the glue frame 58 and becomes the foundation for gluing device main body 102. The sheet guide 122 is a pair of rails to guide the corrugated fiberboard S toward a position at which glue is applied. The support part 124 is supported in a movable state with respect to the basal part 120. Specifically, the support part 124 is supported by the basal part 120 via the first energizing mechanism 128 and the second energizing mechanism 130.

The glue gun 126 is fixed to the support part 124 and is disposed on the downstream side of the sheet guide 122 in the transport direction D. A nozzle 140 is provided on the tip of the glue gun 126 nozzle 140, and glue is injected from the nozzle 140. The glue gun 126 is a contact type glue gun, and injects glue in a state where the nozzle 140 comes into contact with the corrugated fiberboard S.

The sheet guide 127 is fixed to the basal part 120 and is disposed at a position facing the nozzle 140 of the glue gun 126. In the gluing device 56, the corrugated fiberboard S is interposed between the nozzle 140 and the sheet guide 127, and the nozzle 140 and the corrugated fiberboard comes into contact with each other.

The first energizing mechanism 128 is disposed between the basal part 120 and the support part 124, and is energized in a predetermined direction of the support part 124 with respect to the basal part 120, specifically, in a direction F₁ in which the nozzle 140 approaches the sheet guide 127. The first energizing mechanism 128 includes a fixed portion 150, a movable portion 152, a spring 154, and a connection portion 156. The fixed portion 150 is fixed to the basal part 120. The movable portion 152 is fixed to the support part 124. The spring 154 is disposed between the fixed portion 150 and movable portion 152, and the spring is energized in a direction in which the end portions on the support part 124 side of the fixed portion 150 and the movable portion 152 are away from each other. Accordingly, the first energizing mechanism 128 energizes the support part 124 in the direction F₁. In addition, in the first energizing mechanism 128, the connection portion 156 which is connected to the position adjustment mechanism 132 described later is connected to the movable portion 152.

The second energizing mechanism 130 is disposed between the basal part 120 and the support part 124, and energizes the support part 124 in a predetermined direction with respect to the basal part 120, specifically, in the direction in which the nozzle 140 is away from the sheet guide 127, that is, in a direction F₂ opposite to the first energizing mechanism 128. The second energizing mechanism 130 is an air cylinder and includes a fixed portion 160, a movable portion 162, and an air supply unit 164. The fixed portion 160 is fixed to the basal part 120. The movable portion 162 is fixed to the support part 124. The air supply unit 164 adjusts air which is supplied to a portion between the fixed portion 160 and the movable portion 162, can adjust the position of the movable portion 162 with respect to the fixed portion 160, and can adjust a force which is energized in the direction F₂.

The position adjustment mechanism 132 is a mechanism which moves the position of the first energizing mechanism 128 using an eccentric cam mechanism and moves the position of the support part 124. The position adjustment mechanism 132 includes a stop plate 180 which is connected to the connection portion 156, a shaft 182 which is rotatably supported by the basal part 120, an eccentric cam 184 which is fixed to the shaft 182 and is in contact with the stop plate 180, and a motor 186 which rotates the shaft 182.

Since the position adjustment mechanism 132 rotates the shaft 182 using the motor 186 so as to rotate the eccentric cam 184, the position of the stop plate 180 which is in contact with the eccentric cam 184 can move in the movement direction of the movable portion 152. Accordingly, since the position adjustment mechanism 132 controls the rotation of the eccentric cam 184, the position adjustment mechanism 132 can steplessly adjust a distance d₁ between the end portion of the eccentric cam 184 which is in contact with the stop plate 180 and the shaft 182. Preferably, the eccentric cam 184 is subjected to hard chromium plating. Accordingly, it is possible to prevent deformation of the eccentric cam 184, and it is possible to perform an accurate gap adjustment over a long-term period.

In the gluing device 56, since the distance d₁ is adjusted by the position adjustment mechanism 132, it is possible to move the position of the movable portion 152 which is connected to the stop plate 180. Accordingly, it is possible to move the support part 124 and the glue gun 126 which are fixed to the connection portion 152 in the direction F₁ in which the force is exerted. Therefore, it is possible to move the nozzle 140 of the glue gun 126 with respect to the sheet guide 127, and it is possible to steplessly adjust a distance d₂ between the nozzle 140 and the sheet guide 127.

The position detector 134 is a device which detects the position of the member which is moved by the position adjustment mechanism 132. FIG. 5 shows a case where the position of the stop plate 180 is measured, and FIGS. 6 and 7 show a case where the position of the eccentric cam 194 which moves in conjunction with the stop plate 180 is measured. The position detector 134 may measure the position of the stop plate 180, or may measure the position of the eccentric cam 194. Hereinafter, the case where the position of the eccentric cam 194 is measured will be described.

The position detector 134 includes a position sensor 190 and an eccentric cam 194. The eccentric cam 194 is fixed to the shaft 182, has the same shape as that of the eccentric cam 184, and is disposed at the same phase as that of the eccentric cam 184. The eccentric cam 194 is disposed on a surface opposite to the surface on which the basal part 120 and the glue gun 126 of the support part 124 are disposed. That is, the basal part 120 and the support part 124 are disposed between the eccentric cam 194 and the glue gun 126.

The position sensor 190 is a potentiometer or the like which converts a movement amount into a voltage, and has a rod-shaped movable portion 192. In the position sensor 190, the movable portion 192 is in contact with the end surface of the eccentric cam 194. If the eccentric cam 194 rotates and the distance of the end surface which is in contact with the movable portion 192 from the shaft 182 is changed, the position sensor 190 moves along the axial direction of the movable portion 192 according to the change. The position sensor 190 detects the movement of the movable portion 192, and detects the angular position of the eccentric cam 194. The gluing device 56 detects the position of the eccentric cam 184 which rotates in synchronization with the eccentric cam 194 on the basis of the position of the eccentric cam 194, detects the position of the stop plate 180 on the basis of the position of the eccentric cam 184, and detects the distance d₁.

As described above, in the gluing device 56, since forces are applied in the opposite directions by the first energizing mechanism 128 and the second energizing mechanism 130, it is possible to adjust the force which is exerted between the nozzle 140 and the sheet guide 127. In addition, in the gluing device 56, since it is possible to steplessly adjust the gap between the nozzle 140 and the sheet guide 127 using the position adjustment mechanism 132, it is possible to adjust the gap between the nozzle 140 and the sheet guide 127 in accordance with various kinds of corrugated fiberboards S having different characteristics at the position reaching the glue gun 126 due to various flute kinds (A, B, AB, C, E, CB, AA, BB, EB, or the like), basis weight of the raw materials, a corrugation ratio, strength of the corrugated fiberboard, or the like. Accordingly, since the corrugated fiberboard S can be appropriately interposed between the glue gun 126 and the sheet guide 127 and the force which presses the glue gun 126 to the corrugated fiberboard S can be an appropriate force, it is possible to appropriately apply glue to various corrugated fiberboards S. Accordingly, it is possible to improve productivity, and it is possible to increase a quality of a product.

In the gluing device 56, since the position detector 134 detects the position which is changed by the position adjustment mechanism 132, it is possible to control the gap between the nozzle 140 and the sheet guide 127 with higher accuracy, and the force which presses the glue gun 126 to the corrugated fiberboard S can be an appropriate force. Moreover, since the position detector 134 is provided via the support part 124 on the side opposite to the position at which the glue gun 126 is disposed, it is possible to prevent foreign matters from entering the position detector 134, and it is possible to maintain high detection accuracy.

In the gluing device 56, since the operation unit 111 is provided at a usable position even during operation of the carton-forming machine 10 and is a mechanism which can adjusts the position by the motor, it is possible to adjust the gap between the nozzle 140 and the sheet guide 127 without stopping the operation of the carton-forming machine 10. Accordingly, it is possible to improve the productivity.

Here, in the above-described embodiment, the first energizing mechanism 128 which applies a force using the spring 154 and a second energizing mechanism 130 which applies a force using an air cylinder are used. However, the present invention is not limited to this. The first energizing mechanism 128 may be any mechanism as long as it can apply a force in a direction in which the nozzle 140 is pressed to the sheet guide 127, and the first energizing mechanism 128 can use various energizing mechanism which applies a force in a predetermined direction. In addition, the second energizing mechanism 130 may be any mechanism as long as the nozzle 140 can apply a force in a direction which is away from the sheet guide 127, and the second energizing mechanism 130 can use various energizing mechanism which applies a force in a predetermined direction. As the energizing mechanism, various mechanisms such as a mechanism which uses a counterweight or a mechanism which uses an elastic member other than the spring can be used.

Here, in the above-described embodiment, the position adjustment mechanism which uses the eccentric cam is used. However, the present invention is not limited to this. The position adjustment mechanism may be any mechanism as long as it can steplessly adjust the first energizing mechanism 128 and can steplessly adjust the gap between the sheet guide 127 and the nozzle 140 of the glue gun 126.

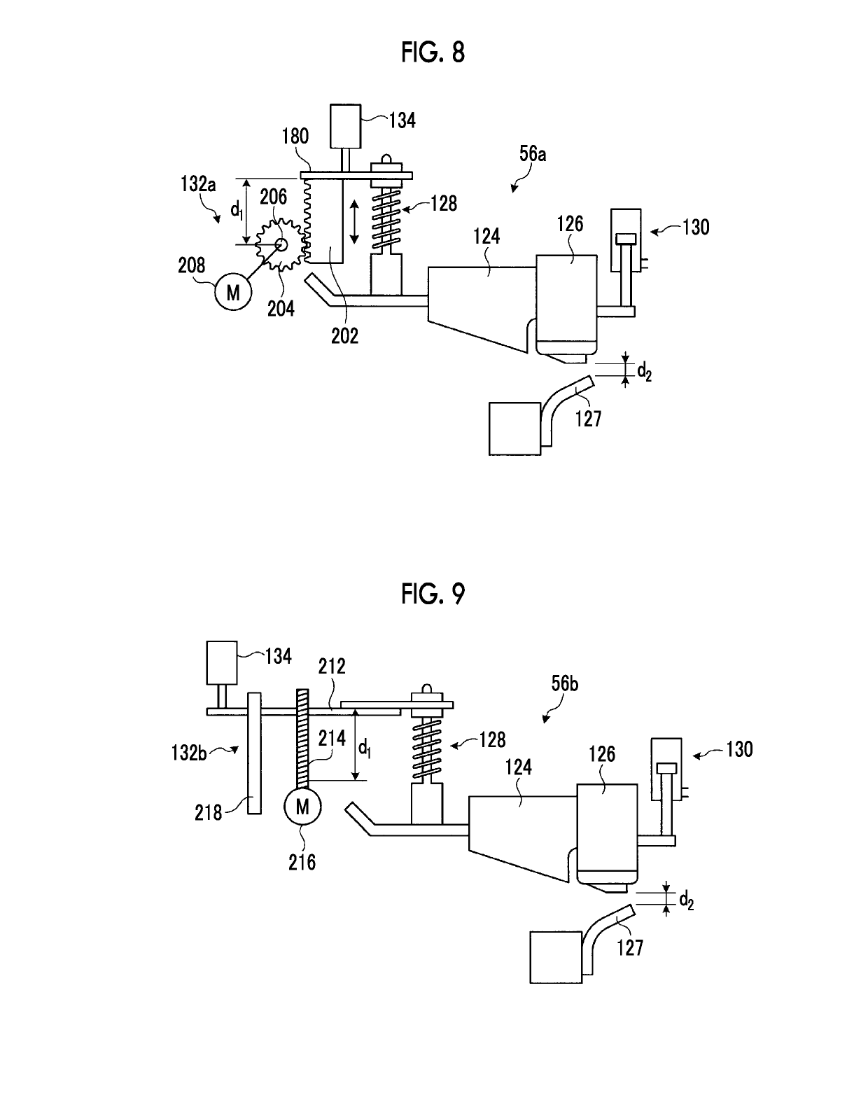

FIG. 8 is a schematic configuration view of a gluing device of a modification example. A gluing device 56a shown in FIG. 8 includes a position adjustment mechanism 132a. In addition, since configurations of the gluing device 56a other than the position adjustment mechanism 132a are similar to those of the gluing device 56, descriptions thereof will be omitted.

The position adjustment mechanism 132a is a mechanism which moves the position of the support part 124 and adjusts the gap by moving the position of the stop plate 180 using a rack and pinion mechanism. The position adjustment mechanism 132a includes the stop plate 180, a rack 202 which is in contact with the stop plate 180, a pinion 204 which meshes with the rack 202, a shaft 206 which is fixed to the pinion 204 and is rotatably supported by the basal part 120, and a motor 208 which rotates the shaft 206.

In the position adjustment mechanism 132a, it is possible to move the position of the rack 202 in an arrow direction by rotating the shaft 206 by the motor 208 to rotate the pinion 204. In addition, it is possible to switch the movement direction of the rack 202 by switching the rotation direction of the shaft 206. Accordingly, in the position adjustment mechanism 132a, it is possible to steplessly adjust the distance d₁ between the end portion of the rack 202 which is in contact with the stop plate 180 and the shaft 206 by controlling the rotation of the pinion 204. In the position adjustment mechanism 132a, it is possible to steplessly adjust the distance d₂ between the nozzle 140 and the sheet guide 127 by adjusting the distance d₁.

FIG. 9 is a schematic configuration view of a gluing device of another modification example. A gluing device 56b shown in FIG. 9 includes a position adjustment mechanism 132b. In addition, since configurations of the gluing device 56b other than the position adjustment mechanism 132b are similar to those of the gluing device 56, descriptions thereof will be omitted.

The gluing device 56b is a mechanism which moves the position of the stop plate 212, moves the position of the support part 124, and adjusts the gap by rotating a screw shaft using a ball screw mechanism as a position adjustment mechanism 132b. The position adjustment mechanism 132b includes a stop plate 212, a screw shaft 214 which is inserted into a hole of the stop plate 212 in which screw grooves are formed, a motor 216 which rotates the screw shaft 214, and a guide rod 218 which is inserted into the stop plate 212 and is disposed so as to be parallel to the screw shaft 214.

In the position adjustment mechanism 132b, it is possible to move the stop plate 212 by rotating the screw shaft 214 using the motor 216. In addition, it is possible to switch the movement direction of the stop plate 212 by switching the rotation direction of the screw shaft 214. In addition, since the guide rod 218 is provided in the position adjustment mechanism 132b, it is possible to prevent the stop plate 212 from rotating, and it is possible to constantly maintain the posture of the screw shaft 214 in the rotation direction. Accordingly, in the position adjustment mechanism 132b, it is possible to steplessly adjust the distance d₁ between the stop plate 212 and the end portion of the screw shaft 214 on the motor 216 side by controlling the rotation of the screw shaft 214. In the position adjustment mechanism 132b, it is possible to steplessly adjust the distance d₂ between the nozzle 140 and the sheet guide 127 by adjusting the distance d₁.

In the gluing device, as described above, even in the cases where the mechanism such as the position adjustment mechanism 132a shown in FIG. 8 or the position adjustment mechanism 132b shown in FIG. 9 is used as the position adjustment mechanism, it is possible to steplessly adjust the distance d₂ between the nozzle 140 and the sheet guide 127.

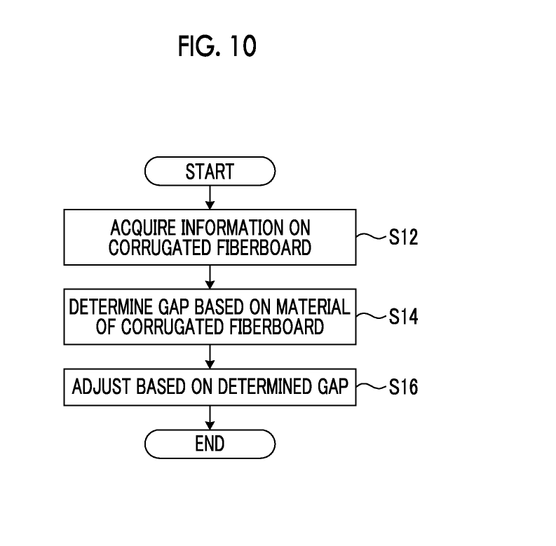

Next, a control operation of the gluing device, specifically, an example of an operation which adjusts the gap between the sheet guide 127 and the nozzle 140 will be described with reference to FIGS. 10 to 13. FIG. 10 is a flowchart showing an example of the control operation of the gluing device. The processes shown in FIG. 10 can be realized by the controller 110.

The controller 110 acquires information on the corrugated fiberboard S (Step S12). Specifically, the controller 110 acquires information which is input or stored as the information corresponding to the corrugated carton to be manufactured or the information on the corrugated fiberboard to be supplied.

If the controller 110 acquires the information on the corrugated fiberboard S, the controller 110 determines (sets) the gap, that is, the distance between the nozzle 140 and the sheet guide 127 on the basis of the material of the corrugated fiberboard S (Step S14). The controller 110 stores a relationship between the material, specifically, the hardness of the corrugated fiberboard S and the gap, and determines the gap on the basis of the stored relationship and the material of the supplied corrugated fiberboard S. Here, for example, as the relationship between the hardness of the corrugated fiberboard S and the gap, the hardness is set five steps such as ultra soft, soft, usually rigid, hard, and ultra hard, and the setting is performed such that the gap is gradually narrowed in the order of ultra soft, soft, usually rigid, hard, and ultra hard.

If the gap is determined, the controller 110 controls the operation of the position adjustment mechanism 132 on the basis of the determined gap, and performs adjustment such that the distance between the nozzle 140 and the sheet guide 127 becomes the distance of the determined gap (Step S16).

Accordingly, in the gluing device 56, since the gap is adjusted based on the material of the corrugated fiberboard, the gap can be adjusted to be suitable for the material. It is possible to change the gap according to the material even when the corrugated fiberboards have the same thicknesses as each other, it is possible to cause the nozzle 140 to come into contact with the corrugated fiberboard S at an appropriate pressure, and it is possible to appropriately apply the glue. In addition, in the above-described embodiment, the gap is determined according to the material. However, the gap may be determined based on the flute of the corrugated fiberboard. In this case, it is possible to set an appropriate gap corresponding to the flute by performing the similar processes. In addition, in the gluing device 56, the thickness of the corrugated fiberboard is set to a reference, and an adjustment amount with respect to the thickness may be adjusted according to the material or the flute.

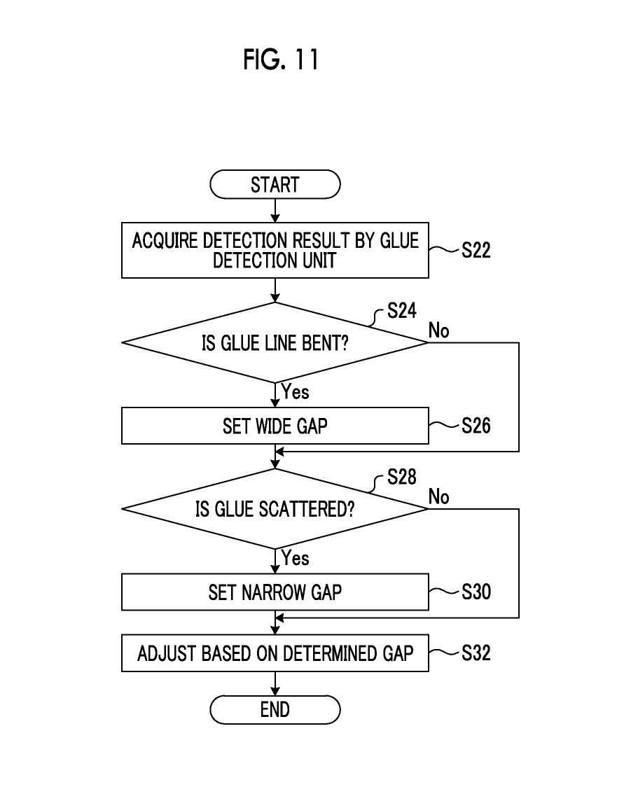

Next, another example of the control operation will be described with reference to FIG. 11. FIG. 11 is a flowchart showing an example of the control operation of the gluing device. The process shown in FIG. 11 is an example of a process which detects the state of the glue which passes through the glue gun 126 and is applied to the corrugated fiberboard S and adjusts the gap on the basis of the state of the glue.

The controller 110 acquires the detection result by the glue detection device 106 (Step S22). Specifically, the controller 110 acquires the information on the application position of the glue obtained by the imaging unit 106a of the glue detection device 106 and the application amount of the glue obtained by the glue amount detection unit 106b.

If the controller 110 acquires the detection result, the controller 110 determines whether or not the glue line is bent (Step S24). The controller 110 determines whether or not the glue line is bent on the basis of the application position of the glue acquired by the imaging unit 106a.

In a case where the controller 110 determines that the glue line is bent (Yes in Step S24), the controller 110 sets a wide gap (Step S26). That is, the controller 110 sets the current gap to a wider gap.

In the case where the controller 110 performs the processing of Step S26, or in the case where the controller 110 determines that the glue line is not bent (No in Step S24), the controller 110 determines whether or not the glue is scattered (Step S28). Specifically, the controller 110 detects whether or not a predetermined amount of glue is applied based on the detection result obtained by the glue amount detection unit 106b, and the controller 110 determines that the glue is scattered in a case where the application amount is smaller than a lower limit or in a case where the application amount is greater than an upper limit.

In a case where the controller 110 determines that the glue is scattered (Yes in Step S28), the controller 110 sets a narrow gap (Step S30). That is, the controller 110 sets the current gap to a narrower gap.

In the case where the controller 110 performs the processing of Step S30, or in the case where the controller 110 determines that the glue is not scattered (No in Step S28), the controller 110 controls the operation of the position adjustment mechanism 132 on the basis of the determined gap and performs the adjustment such that the distance between the nozzle 140 and the sheet guide 127 becomes the distance of the determined gap (Step S32).

As described above, in the gluing device 56, since whether or not the glue line is bent or whether or not the glue is scattered is detected based on the detection result by the glue detection device 106, the gap is widened in a case where a pressing force becomes stronger and the position of the corrugated fiberboard S is deviated. In addition, in a case where the pressing force becomes weaker and the nozzle 140 and the corrugated fiberboard S do not come into appropriate contact with each other, it is possible to narrow the gap. Accordingly, it is possible to cause the nozzle 140 to come into contact with the corrugated fiberboard S at an appropriate pressure, and it is possible to appropriately apply the glue.

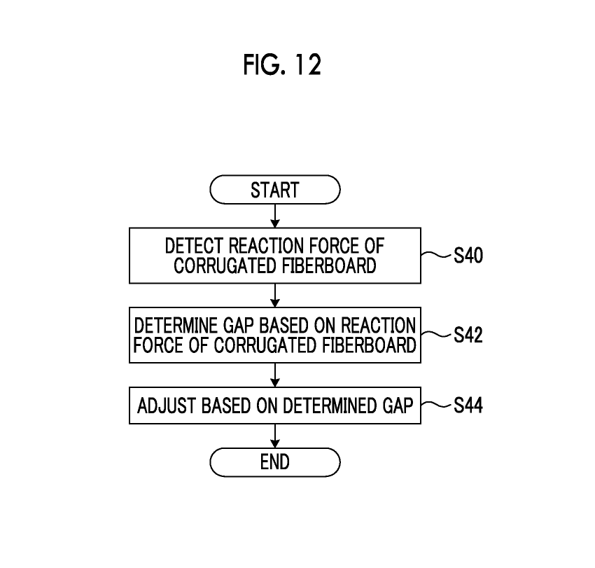

Next, still another example of the control operation will be described with reference to FIG. 12. FIG. 12 is a flowchart showing still another example of the control operation of the gluing device. The process shown in FIG. 12 is an example of a process which adjusts the gap on the basis of the result detected by the reaction force detection device 108. In addition, in the processing shown in FIG. 12, preferably, the gap is set and the processing is performed so as to adjust the gap.

The controller 110 detects the reaction force of the corrugated fiberboard S (Step S40). Specifically, the controller 110 acquires the result detected by the reaction force detection device 108.

If the controller 110 detects a reaction force, the controller 110 determines the gap, that is, the distance between the nozzle 140 and the sheet guide 127 on the basis of the reaction of the corrugated fiberboard S (Step S42). Specifically, the controller 110 determines the amount of the change of the gap on the basis of the reaction force with reference to the current gap.

If the controller 110 determines the gap, the controller 110 controls the operation of the position adjustment mechanism 132 on the basis of the determined gap, and performs the adjustment such that the distance between the nozzle 140 and the sheet guide 127 becomes the distance of the determined gap (Step S44).

As described above, in the gluing device 56, since the gap is adjusted based on the detection result by the reaction force detection device 108, it is possible to cause the nozzle 140 to come into contact with the corrugated fiberboard S at an appropriate pressure, and it is possible to appropriately apply the glue. That is, in the gluing device 56, since the material of the corrugated fiberboard S, the degree of hardness, the sheet thickness, weather conditions, and characteristics which are changed by production timing are determined from the reaction force detection value of the reaction force detection device 108, and the gap is adjusted based on the result, it is possible to cause the nozzle 140 to come into contact with the corrugated fiberboard S at an appropriate pressure, and it is possible to appropriately apply the glue.

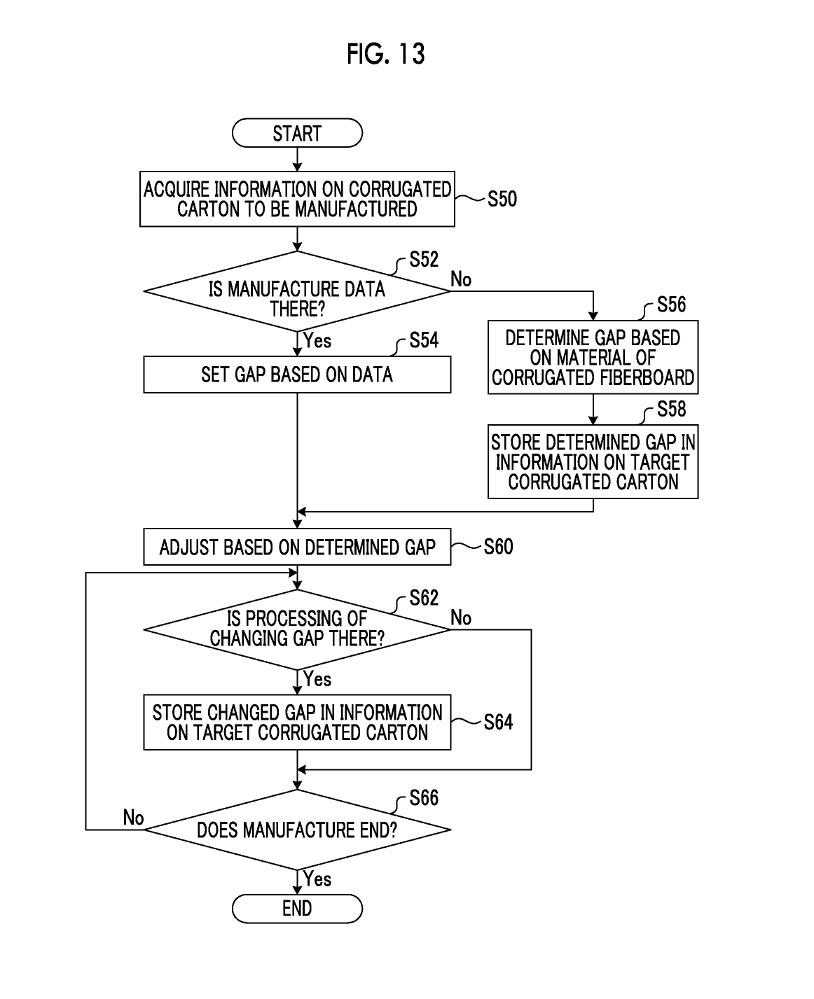

Next, still another example of the control operation will be described with reference to FIG. 13. FIG. 13 is a flowchart showing still another example of the control operation of the gluing device. The process shown in FIG. 13 is an example of a process which is performed when the corrugated carton is manufactured.

The controller 110 acquires information on the corrugated carton to be manufactured (Step S50). The information on the corrugated carton to be manufactured is information which is input by an operator. If controller 110 acquires the information on the corrugated carton to be manufactured, the controller 110 determines whether or not there is the manufacture data, that is, whether or not the same corrugated carton was manufactured in the past (Step S52).

In a case where the controller 110 determines that there is the manufacture data (Yes in Step S52), the controller 110 set a gap on the basis of the data (Step S54). The controller 110 sets the gap to the value of the gap between the sheet guide 127 and the nozzle 140 when the corrugated carton was manufactured in the past.

In a case where the controller 110 determines that there is no manufacture data (No in Step S52), the controller 110 determines the gap on the basis of the material of the corrugated fiberboard (Step S56). That is, the above-described processing of FIG. 10 is performed. In addition, preferably, the controller 110 determines the gap in consideration of the kind or the thickness of the flute, in addition to the material. If the controller 110 determines the gap, the controller 110 stores the determined gap in the information on the target corrugated carton (Step S58).

If the controller 110 performs the processing of Step S54 or the processing of Step S58, the controller 110 controls the operation of the position adjustment mechanism 132 on the basis of the determined gap and performs the adjustment such that the distance between the nozzle 140 and the sheet guide 127 becomes the distance of the determined gap (Step S60).

If the controller 110 adjusts the gap, the manufacture of the corrugated carton starts. If the manufacture starts, the controller 110 determines whether or not there is processing of changing the gap (Step S62). The controller 110 determines whether or not the processing of changing the gap is performed by the processing of FIG. 11 or FIG. 12.

In a case where the controller 110 determines that there is the processing of changing the gap (Yes in Step S62), the controller 110 stores the changed gap in the information on the target corrugated carton (Step S64). That is, in the case where the gap is changed, the controller 110 overwrites the information on the gap associated with the information on the corrugated carton.

In a case where the controller 110 performs the processing of Step S64, or in a case where the controller 110 determines that there is no processing of changing the gap (No in Step S62), the controller 110 determines whether or not the manufacture ends (Step S66). In a case where the controller 110 determines that the manufacture does not end (No in Step S66), the controller 110 returns the step to Step S62 and continues the determination processing. If the controller 110 determines that the manufacture ends (Yes in Step S66), the controller 110 ends the present processing.

As shown in FIG. 13, in the gluing device 56, since the information on the gap associates with the information on the corrugated carton to be manufactured, and the information is updated every time the gap is adjusted, it is possible to set an appropriate gap for each corrugated carton to be manufactured. In addition, since it is not necessary to newly adjust the gap each time, the processing is simplified. In the gluing device 56, the processing of FIGS. 10 to 13 may be performed so as to be combined, or may be performed as respective separate processing.

Moreover, in each embodiment described above, the carton-forming machine 10 is configured of the sheet feeding section 11, the printing section 21, the sheet discharging section 31, the die-cut section 41, the folding section 51, and the counter-ejector section 61. However, the present invention is not limited to this configuration, and a drying section a defective product removal section, or the like may be provided. In addition, the counter-ejector section 61 may not be provided.

### REFERENCE SIGNS LIST

10: carton-forming machine
11: sheet feeding section
21: printing section
31: sheet discharging section
41: die-cut section
43: anvil cylinder
44: knife cylinder
51: folding section
52: upper transport belt
53: lower transport belt
54: forming belt
55: gauge roller
56: gluing device
57: main frame
58: glue frame
59: movement mechanism
61: counter-ejector section
82: folding bar
102: gluing device main body
104: glue tank
106: glue detection device
106a: imaging unit
106b: glue amount detection unit
108: reaction force detection device
110: controller
111: operation unit
120: basal part
122, 127: sheet guide
124: support part
126: glue gun
128: first energizing mechanism
130: second energizing mechanism
132: position adjustment mechanism
134: position detector
140: nozzle
150, 160: fixed portion
152,162,192: movable portion
154: spring
156: connection portion
164: air supply unit
180, 212: stop plate
182, 206: shaft
184, 194: eccentric cam
186, 208, 216: motor
190: position sensor
202: rack
204: pinion
214: screw shaft
218: guide rod

1. A gluing device, comprising:
a sheet guide which guides a corrugated fiberboard;
a basal part which has a fixed relative position with respect to the sheet guide;
a support part which is disposed so as to be relatively movable with respect to the basal part;
a glue gun which is fixed at a position of the support part facing the sheet guide, and comes into contact with and applies glue to a glued portion within a seam margin at a side end of the corrugated fiberboard passing through the sheet guide;
a first energizing mechanism which is disposed between the basal part and the support part and energizes the support part in a direction toward the sheet guide;
a second energizing mechanism which is disposed between the basal part and the support part and energizes the support part in a direction away from the sheet guide; and
a position adjustment mechanism which is disposed between the first energizing mechanism and the basal part, steplessly adjusts a position of the support part in a direction along a direction of a force exerted by the first energizing mechanism, and adjusts a gap between the glue gun and the sheet guide.

2. The gluing device according to claim 1,
wherein the position adjustment mechanism rotates an eccentric cam to adjust the position of the support part.

3. The gluing device according to claim 1,
wherein the first energizing mechanism includes a spring, and
wherein the second energizing mechanism is an air cylinder.

4. The gluing device according to claim 1, further comprising:
a position detector which detects the position of the support part in the direction along the direction of the force exerted by the first energizing mechanism; and
a controller which controls the operation of the position adjustment mechanism on the basis of the position detected by the position detector and adjusts the gap.

5. The gluing device according to claim 4,
wherein the position detector is disposed on a surface opposite to the surface on which the glue gun of the support part is disposed.

6. The gluing device according to claim 4,
wherein the controller acquires information on the corrugated fiberboard, widens the gap as a flute of the corrugated fiberboard is soft, and narrows the gap as the flute is hard.

7. The gluing device according to claim 4, further comprising:
a glue inspection unit which is disposed on the downstream side of the glue gun in a transport direction of the corrugated fiberboard and detects the glue applied to the corrugated fiberboard,
wherein the controller adjusts the gap on the basis of the result by the glue inspection unit.

8. The gluing device according to claim 4, further comprising:
a reaction force detection device which is disposed on the upstream side of the glue gun in the transport direction of the corrugated fiberboard and comes into contact with the corrugated fiberboard to detect a reaction force received from the corrugated fiberboard,
wherein the controller adjusts the gap on the basis of the result by the reaction force detection device.

9. A carton-forming machine, comprising:
a sheet feeding section which supplies a corrugated fiberboard;
a printing section which performs printing on the corrugated fiberboard;
a sheet discharging section which applies creasing lines to and forms grooves on the surface of the corrugated fiberboard;
a sheet folding device which includes the gluing device according to claim 1, applies glue to a glued portion within a seam margin on a side end of the corrugated fiberboard, and folds both end portions of the corrugated fiberboard in a width direction to join both end portions of the corrugated fiberboard in the width direction and form a carton body; and
a counter-ejector section which stacks the carton bodies while counting the carton bodies and thereafter, discharges the carton bodies for each predetermined number.
